(19) United States
(12) Patent Application Publication
(10) Pub. No.: US 2011/0093639 A1
(43) Pub. Date: Apr. 21, 2011

(54) Secure Communications Between and Verification of Authorized CAN Devices

(75) Inventor: Patrick K. Richards, Peoria, AZ (US)

(73) Assignee: MICROCHIP TECHNOLOGY INCORPORATED, Chandler, AZ (US)

(21) Appl. No.: 12/581,225

(22) Filed: Oct. 19, 2009

(51) Int. Cl. G06F 13/36

(52) U.S. Cl. 710/310

(57) ABSTRACT

Encrypted encoding and decoding of identification data of CAN bus devices for communications therebetween provides deterrence of theft and unauthorized access of these secure CAN bus devices. Each one of the CAN bus devices is considered a “node” on the CAN bus for communications purposes. By using a unique encryption code stored in each of the “authorized” CAN bus devices, unauthorized CAN bus nodes will not be able to communicate with the authorized, e.g., secure, CAN bus nodes functioning in a CAN system.

### TECHNICAL FIELD

The present disclosure relates to controller area network (CAN) bus devices, and more particularly, to CAN bus devices having encryption to authenticate their use in a CAN system and/or secure communications between encryption enabled CAN bus devices.

### BACKGROUND

CAN is an International Standards Organization (ISO) defined serial communications protocol originally developed for the automotive industry to replace the complex wiring harness with a two-wire bus. CAN bus system implementations have high immunity to electrical interference, and advanced error detection and correction capabilities. Use of the CAN bus devices has been widely accepted in a variety of industries including automotive, marine, medical, manufacturing and aerospace.

CAN bus compatible modules can be easily and inexpensively implemented to form complex systems that communicate with one another. However, there is a need for security, improper use and/or theft deterrence in some industries where the CAN bus modules can be stolen for resale on the black market and/or theft of trade secrets through industrial espionage. For example, to make a high value part (e.g., car radio) anti-theft, a special secret code must be manually entered if power is ever removed from the high value part. However, for other high value items such as airbags, seats, headlights, etc., no practical solution has yet to be found.

### SUMMARY

Therefore it is desirable for unauthorized use and/or antitheft deterrence measures to be built into valuable parts, e.g., vehicle modules and assemblies, and for industrial espionage deterrence by encryption of data protocols of proprietary module functions. In addition, maintaining CAN message integrity and security are important for the prevention of unauthorized access and operation of industrial equipment, e.g., power plant generator and substation controls.

According to the teachings of this disclosure, use of encrypted encoding and decoding of data by CAN bus devices during communications therebetween will provide deterrence of theft, and unauthorized use and access of these encryption enabled CAN bus modules or devices (modules and devices will be used interchangeably herein). Each one of the CAN bus devices is considered a “node” on the CAN bus for communications purposes. Thus, by using a unique encryption code associated with all of the “authorized” CAN bus devices, unauthorized CAN bus nodes will not be able to communicate with the authorized, e.g., secure, CAN bus nodes.

A security peripheral such as the KEELOQ® system, a registered trademark of Microchip Technology Incorporated, may be used to encrypt/decrypt data for transmission via the CAN bus to authorized CAN bus nodes. The KEELOQ® system and other applications thereof are more fully described in commonly owned U.S. Pat. Nos. 6,985,472; 6,191,701; 6,175,312; 6,166,650; 6,108,326; 5,841,866; 5,686,904 and 5,517,187; all of which are hereby incorporated by reference herein for all purposes. The combination of CAN and KEELOQ®, will be referred to hereinafter as “CANloq.”

According to the teachings of this disclosure, the KEELOQ® data (32-bit encrypted portion plus 32-bit fixed portion) may be one-to-one mapped to the CAN message data field. The CAN Specification 2.0 parts A and B (see www.can.bosch.com/docu/can2spec.pdf); and ISO 11898 all versions and dates, are hereby incorporated by reference herein for all purposes.

The combination of the KEELOQ® encryption/decryption and CAN bus serial data bus protocols, hereinafter referred to as “secure CAN” provides the ability for only those authorized CANloq modules to communicate with one another and further provides protection from “hacking” of the CAN bus system by unauthorized users. In addition, an authorized CANloq module that has been illegally removed from its secure CAN environment can be programmed to become inoperative and/or send out an alert when attempts are made to access it by unauthorized queries (not having the correct KEELOQ® code(s)).

A CANloq module may be authenticated at the time of installation into a secure CAN system by programming it with a unique security code. For example, but not limited to, a vehicle identification number (VIN) may be used to create the encryption/decryption software keys for the secure CANloq module. This installation/initialization procedure may be performed with a secure programming device that can also verify if the VIN to be programmed and/or a VIN that is stored in the secure CANloq module is on a “watch” list of stolen VIN identified parts. The CANloq module may have a factory code that prevents it from being programmed by any means other then a factory authorized programmer having VIN verification. It is contemplated and within the scope of this disclosure that a unique security code may also be created from a module serial number, a manufacturer and/or user defined password, a manufacturer code, etc.

According to a specific example embodiment, as described in the present disclosure, an apparatus for secure communications between and verification of authorized controller area network (CAN) devices comprises: a CAN engine having a CAN bus interface adapted for coupling to a CAN bus; a message assembly buffer having a receive message buffer and a transmit message buffer, the message assembly buffer is coupled to the CAN engine for receiving and transmitting CAN formatted messages; a security peripheral having an encryption encoder and a decryption decoder, wherein the encryption encoder is coupled to the transmit message buffer and the decryption decoder is coupled to the receive message buffer; a security key register storing a security key; a synchronization counter; a fixed data register; at least one CAN transmit buffer coupled to the synchronization counter, fixed data register and the encryption encoder; and at least one CAN receive buffer coupled to the synchronization counter, fixed data register and the decryption decoder; wherein the encryption encoder generates encrypted transmit data from transmit data in the at least one CAN transmit buffer using the security key from the security key register and places the encrypted transmit data into the transmit message buffer, and the decryption decoder converts encrypted received data in the receive message buffer to received data using the security key from the security key register and places the received data into the at least one CAN receive buffer.

According to another specific example embodiment as described in the present disclosure, a system for secure communications between and verification of authorized controller area network (CAN) devices operating in a CAN system comprises: a plurality of CAN devices, wherein each of the plurality of CAN devices comprises a CAN engine having a CAN bus interface adapted for coupling to a CAN bus; a message assembly buffer having a receive message buffer and a transmit message buffer, the message assembly buffer is coupled to the CAN engine for receiving and transmitting CAN formatted messages; a security peripheral having an encryption encoder and a decryption decoder, wherein the encryption encoder is coupled to the transmit message buffer and the decryption decoder is coupled to the receive message buffer; a security key register storing a security key; a synchronization counter; a fixed data register; at least one CAN transmit buffer coupled to the synchronization counter, fixed data register and the encryption encoder; and at least one CAN receive buffer coupled to the synchronization counter, fixed data register and the decryption decoder; wherein the encryption encoder generates encrypted transmit data from transmit data in the at least one CAN transmit buffer using the security key from the security key register and places the encrypted transmit data into the transmit message buffer, and the decryption decoder converts encrypted received data in the receive message buffer to received data using the security key from the security key register and places the received data into the at least one CAN receive buffer.

According to still another specific example embodiment as described in the present disclosure, a method for secure communications between and verification of authorized controller area network (CAN) devices comprises the steps of: reading a CAN device identification; comparing the CAN device identification with a CAN system identification, wherein if the CAN device identification matches the CAN system identification, then activating the CAN device; sending status of the activated CAN device to the CAN system; and saving the status of the activated CAN device.

According to yet another specific example embodiment as described in the present disclosure, a method for secure communications between and verification of authorized controller area network (CAN) devices comprises the steps of: reading a first CAN device identification; determining if the first CAN device identification is valid; and replacing the first CAN device identification with a second CAN device identification if the first CAN device identification is valid.

### BRIEF DESCRIPTION OF THE DRAWINGS

A more complete understanding of the present disclosure thereof may be acquired by referring to the following description taken in conjunction with the accompanying drawings, wherein:

FIG. 1 illustrates a schematic block diagram of a CAN bus system comprising a plurality of CAN devices;

FIG. 2 illustrates schematic data bit mapping between a CAN message field and a KEELOQ® message field, according to a specific example embodiment of this disclosure;

FIG. 3 illustrates various examples of encrypted and non-encrypted CAN messages, according to the teachings of this disclosure;

FIG. 4 illustrates a schematic block diagram of the high level operation of a CANloq module, according to a specific example embodiment of this disclosure;

FIG. 5 illustrates a schematic functional block diagram of a CANloq module in combination with a digital processor, according to the teachings of this disclosure;

FIG. 6 illustrates a schematic flow diagram of the verification of an authorized CANloq module in a CANloq enabled system, according to the teachings of this disclosure; and

FIG. 7 illustrates a schematic flow diagram of the validation of a CANloq module and changing the validated CANloq module identification to match the CANloq system identification, according to the teachings of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawing, the details of specific example embodiments are schematically illustrated. Like elements in the drawings will be represented by like numbers, and similar elements will be represented by like numbers with a different lower case letter suffix.

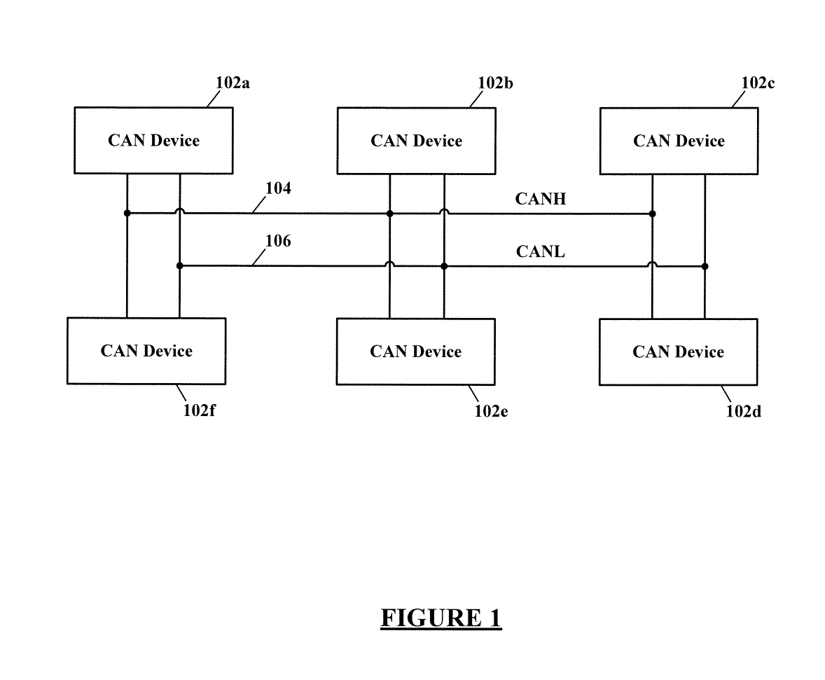

Referring to FIG. 1, depicted is a schematic block diagram of a CAN bus system comprising a plurality of CAN devices. A plurality of CAN devices 102 communicate over a CAN bus comprising signal lines CANH 104 and CANL 106. The CAN devices 102 may be modular and easily replaceable in a system such as a vehicle.

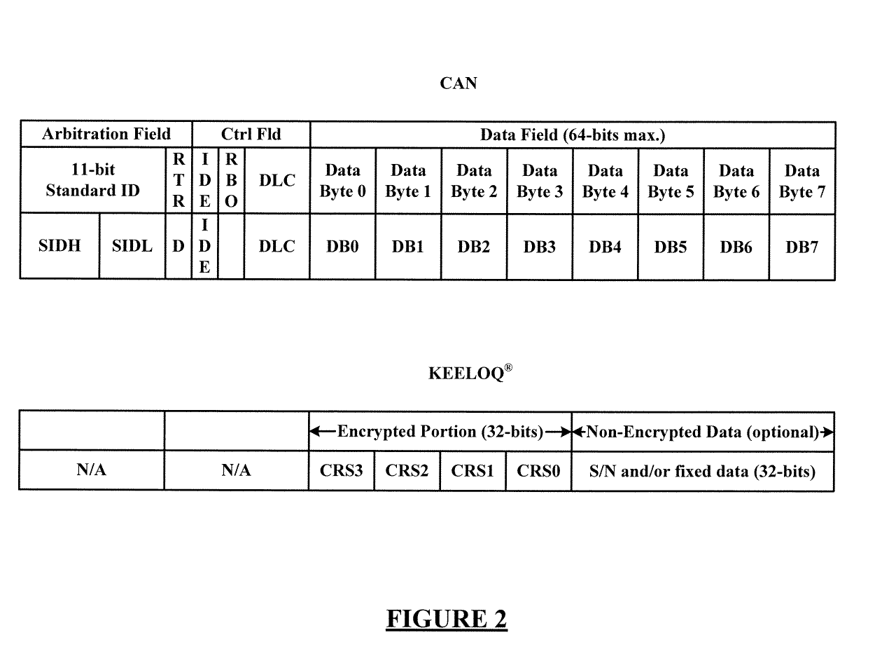

Referring to FIG. 2, depicted is schematic data bit mapping between a CAN message field and a KEELOQ® message field, according to a specific example embodiment of this disclosure. The KEELOQ® encryption algorithm may utilize 64-bits of data (32-bits encrypted and 32-bits fixed) for a transmitted message. The CAN bus protocol allows up to 64-bits of data for each message which may be used to map the KEELOQ® format into the CAN format so as to implement secure communications for a CANloq module. Shown in FIG. 2 is the 11-bit CAN identifier, however, a 29-bit CAN identifier may also be utilized in a similar fashion. Thus, the CANloq format may be implemented regardless of the CAN identifier type (e.g., 11-bits or 29-bits). Therefore, the necessary KEELOQ® data bits may be directly mapped one-to-one to the CAN message field, using either the standard 11-bit or the extended 29-bit CAN identifier. The message type is inherent in the CAN protocol, therefore, identifying a message as being encrypted is no exception. Since the higher layer(s) of the CAN protocol are open, how messages are identified may be specified by the system designer.

Therefore, according to the teachings of this disclosure, a CANloq device encrypts/decrypts data/messages automatically so as to allow for secure point-to-point or multicast data communications between related CANloq devices. The CANloq device functions as a CAN controller with the ability to encrypt/decrypt data. Since the CAN specification only defines the Data Link Layer and the upper portion of the Physical Layer, the system designer is free to develop a data communications protocol which matches the control and monitoring requirements of a system while still being secure and robust. Thus, a secure data communications system may be created which has the same level of flexibility of unsecured CAN systems. Therefore, a secure CAN system can be developed much like the development of a traditional unsecured CAN system.

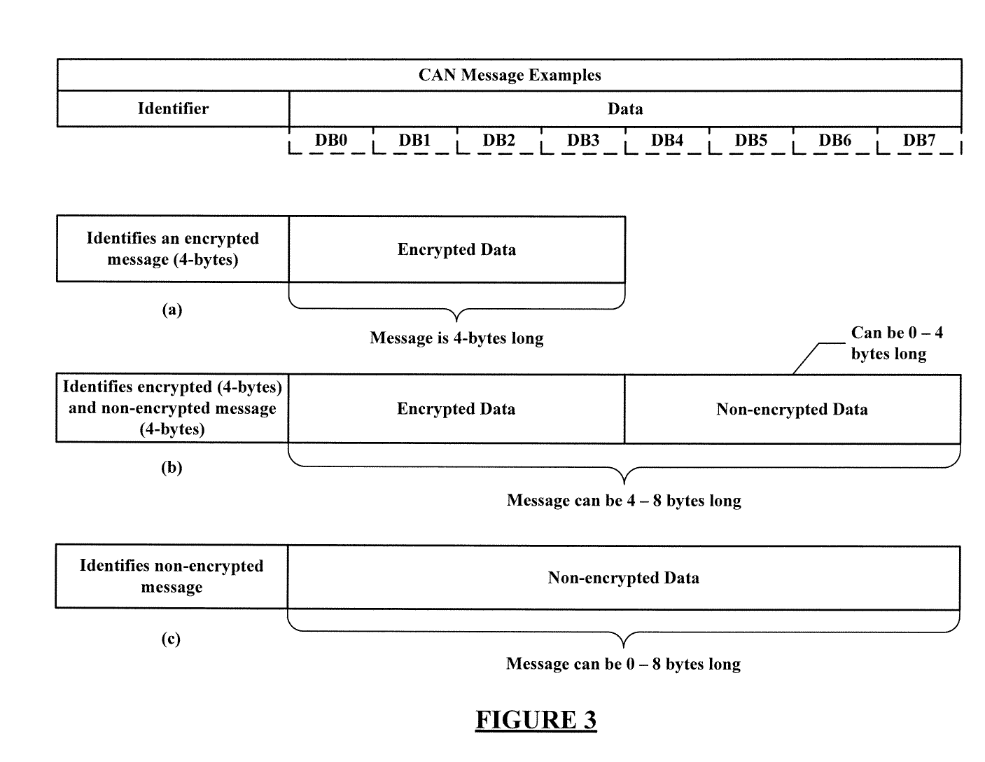

FIG. 3 illustrates various examples of encrypted and non-encrypted CAN messages, according to the teachings of this disclosure. An encrypted or non-encrypted message may be specified in the Identifier portion of the CAN message protocol. As illustrated in (a), the CAN identifier specifies an encrypted message to follow as being four-bytes long (32 bits) which contains the KEELOQ® information (CRS3, CRS2, CRS1, CRS0). As illustrated in (b), the CAN identifier specifies an encrypted message (four-bytes) as shown in (a) and non-encrypted data that may be from zero to four bytes. As illustrated in (c), the CAN identifier specifies an non-encrypted message having up to eight (8) bytes of data.

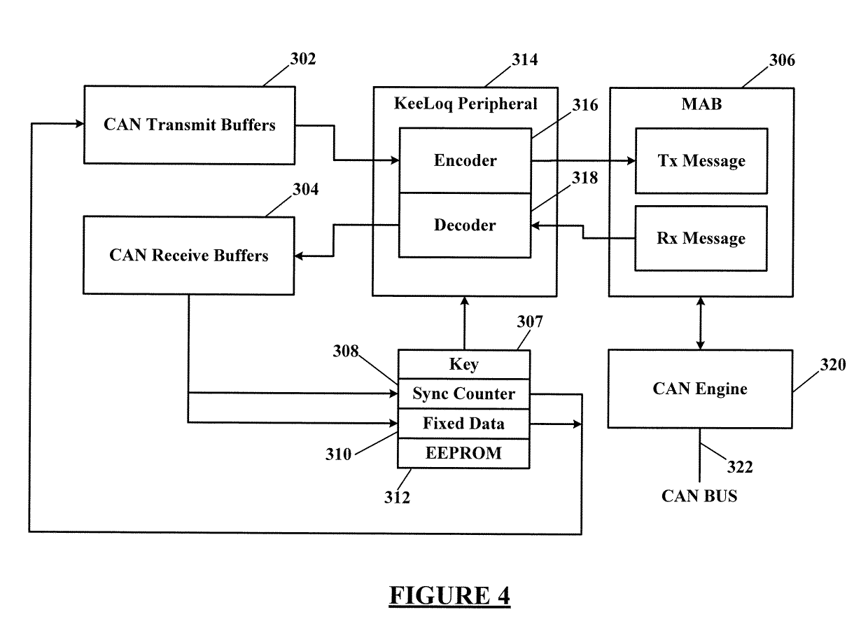

Referring to FIG. 4, depicted is a schematic block diagram of the high level operation of a CANloq module, according to a specific example embodiment of this disclosure. The CAN transmit buffers 302 and the CAN receive buffers 304 contain the non-encrypted data useable by the CANloq device application. The message assembly buffer (MAB) 306 contains the CAN message (data and overhead) with encrypted data. A security peripheral 314, e.g., KEELOQ® peripheral, comprises an encryption encoder 316 and a decryption decoder 318. A security key for use by the security peripheral 314 is stored in the security key register 307.

Operation of a KEELOQ® peripheral is more fully described in commonly owned U.S. Pat. Nos. 6,985,472; 6,191,701; 6,175,312; 6,166,650; 6,108,326; 5,841,866; 5,686,904 and 5,517,187; all hereby incorporated by reference herein for all purposes. Operation of CAN devices is more fully described in The CAN Specification 2.0 parts A and B (see www.can.bosch.com/docu/can2spec.pdf), and ISO 11898 all versions and dates, hereby incorporated by reference herein for all purposes.

For example, in transmitting messages the identifier and data are loaded as shown in FIG. 2, e.g., at start-up or run time. The serial number, e.g., VIN, (part of the fixed data stored in the fixed data register 310) and synchronization counter 308 (part of the encrypted field) may also be loaded from non-volatile memory 312, e.g., electrically erasable and programmable memory (EEPROM). Other storage locations and implementations for the serial number and synchronization are contemplated herein and would be readily implemented by one having ordinary skill in digital circuit design and having the benefit of this disclosure.

Once the CAN transmit buffer 302 is loaded, the information contained therein may be passed to the KEELOQ® peripheral 314 for encoding in the encoder 316. The encoded data from the encoder 316 is then passed to the MAB 306 where it is framed with the CAN protocol and sent to the CAN engine 320 for delivery onto the CAN bus 322.

Receiving messages is basically the reverse of transmitting messages as described hereinabove. For example, a received message from the CAN bus 322 is received by the CAN engine 320 and send to the MAB 306. In the MAB 306 the received message is stripped of the CAN protocol frame then sent to the decoder 318 of the KEELOQ® peripheral 314. The CAN receive buffer 304 sends the unencrypted serial number and synchronization count to the fixed data storage 310 and the synchronization counter 308, respectively. Optionally, the serial number and synchronization counter values may be saved in the non-volatile memory 312.

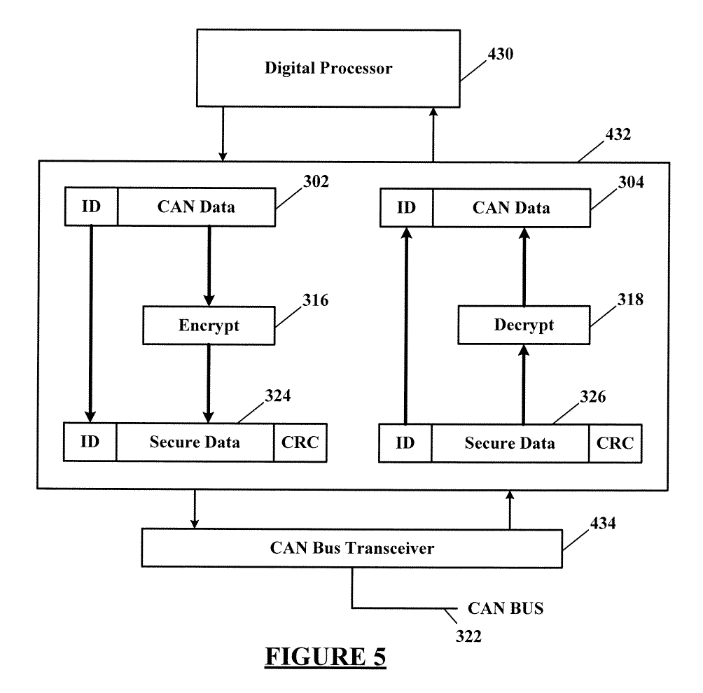

Referring to FIG. 5, depicted is a schematic functional block diagram of a CANloq module in combination with a digital processor, according to the teachings of this disclosure. A digital processor 430 is coupled to the CANloq peripheral 432 which is coupled to the CAN bus transceiver 434 (e.g., part of the CAN engine 320). The CANloq peripheral 432 comprises CAN transmit buffers 302, encryption encoder 316, transmit message buffer 324, CAN receive buffers 304, decryption decoder 318 and receive message buffer 326. The CAN bus transceiver 434 is coupled to the CAN bus 322. The digital processor 430 may be a microcontroller, microprocessor, digital signal processor, programmable logic array (PLA), application specific integrated circuit (ASIC), etc.

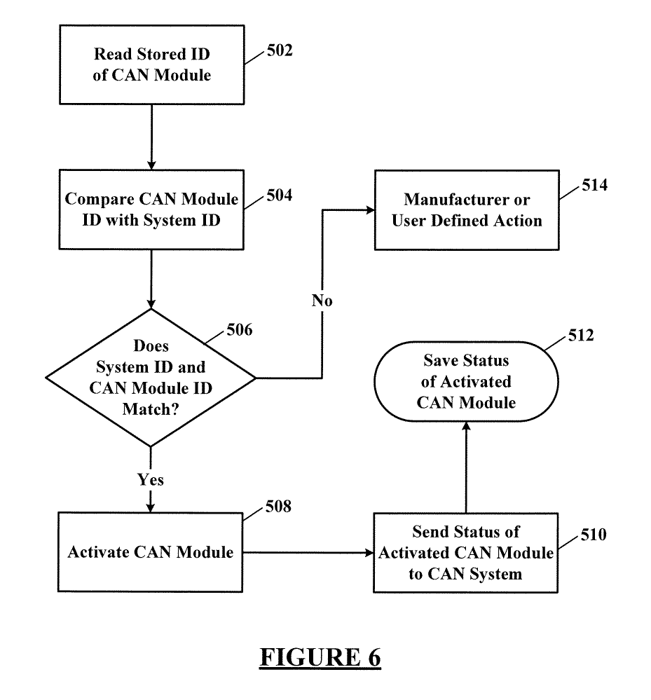

Referring to FIG. 6, depicted is a schematic flow diagram of the verification of an authorized CANloq module in a CANloq enabled system, according to the teachings of this disclosure. In step 502, the stored identification of the CANloq module, e.g., vehicle identification number (VIN), is read by a CANloq enabled system bus master. In step 504, the CANloq enabled system bus master compares the identification from the CANloq module to the CANloq enabled system identification. If there is a match between the CANloq enabled system identification and the identification of the CANloq module in step 506, then in step 508 the CANloq module is activated, otherwise the CANloq module is not activated. In step 510 the status of the activated CANloq module is sent to the CANloq enabled system bus master, and in step 512 this status is saved in the bus master. Wherein the CANloq module becomes authorized to function in the CANloq enabled system. If there is not a match between the CANloq enabled system identification and the identification of the CANloq module in step 506, then in step 514 an action may occur that can be manufacturer or user defined such as, for example but not limited to, operational lock-out of the CANloq module from further functioning until a reset code is applied to the CANloq module, acceptance of a selectable number of tries before lock-out may occur, alert to a central monitoring system of an incorrect or misapplied CANloq module, etc. The CANloq module(s) may have incorporated therein a feature of alerting a monitoring facility of a malfunction and/or improper use thereof (e.g., theft, improper CANloq module configuration or obsolete software version, etc.). Alerting of the monitoring facility may be facilitated from the vehicle through a satellite communications network such as, for example but not limited to, OnStar (OnStar is a registered trademarks of OnStar, LLC).

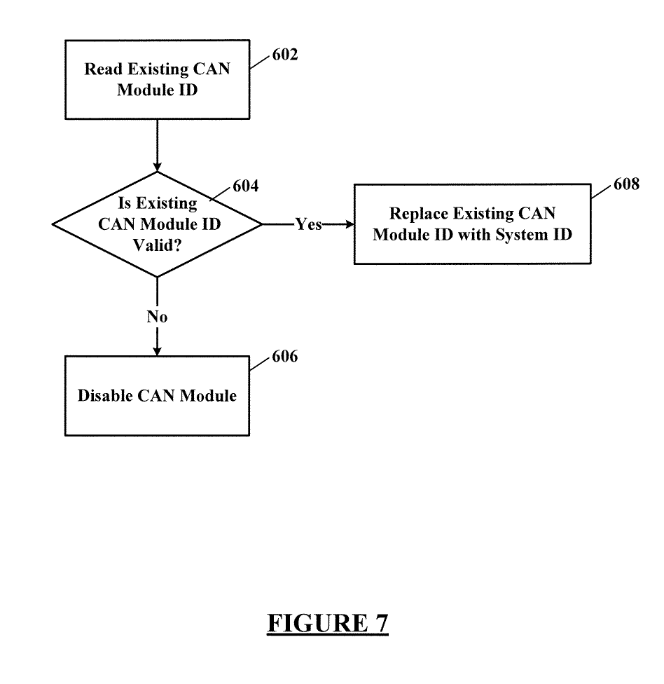

Referring to FIG. 7, depicted is a schematic flow diagram of the validation of a CANloq module and changing the validated CANloq module identification to match the CANloq system identification, according to the teachings of this disclosure. In step 602, the stored (existing) identification of a CANloq module is read. Step 604 determines if the read existing CANloq module identification is valid. If the existing identification is valid, then in step 608 a new identification replaces the existing (previous) identification of the CANloq module. If the existing identification is not valid, e.g., stolen module, then in step 606 the CANloq module is disabled and may be rendered inoperable.

A validation and programming device (not shown), e.g., acting as a CAN bus master, may be used to determine the validity of the existing identification of the CANloq module by comparing the existing identification with an identification data base that may be updated, for example but not limited to, a master identification data base over the Internet. This master identification data base may be kept current by law enforcement agencies, parts dealers, etc. Connection of the validation and programming device to the CANloq module may be through, but not limited to, the CAN bus 322. Once the identification of the CANloq module has been validated, then the validation and programming device will update the CANloq module with the new identification of the CANloq system so that the CANloq module may be used therewith. It is contemplated and within the scope of this disclosure that reporting of improper operation or application of the CANloq module, and/or configured thereof with incompatible or obsolete software versions may be made to a monitoring facility. The monitoring facility may be contacted from the vehicle through a satellite communications network such as, for example but not limited to, OnStar (OnStar is a registered trademarks of OnStar, LLC), as more fully described hereinabove.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An apparatus for secure communications between and verification of authorized controller area network (CAN) devices, comprising:
a CAN engine having a CAN bus interface adapted for coupling to a CAN bus;
a message assembly buffer having a receive message buffer and a transmit message buffer, the message assembly buffer is coupled to the CAN engine for receiving and transmitting CAN formatted messages;
a security peripheral having an encryption encoder and a decryption decoder, wherein the encryption encoder is coupled to the transmit message buffer and the decryption decoder is coupled to the receive message buffer;
a security key register storing a security key;
a synchronization counter;
a fixed data register;
at least one CAN transmit buffer coupled to the synchronization counter, fixed data register and the encryption encoder; and
at least one CAN receive buffer coupled to the synchronization counter, fixed data register and the decryption decoder;
wherein
the encryption encoder generates encrypted transmit data from transmit data in the at least one CAN transmit buffer using the security key from the security key register and places the encrypted transmit data into the transmit message buffer, and
the decryption decoder converts encrypted received data in the receive message buffer to received data using the security key from the security key register and places the received data into the at least one CAN receive buffer.

2. The apparatus according to claim 1, further comprising a non-volatile memory for the security key register, the synchronization counter and the fixed data register.

3. The apparatus according to claim 1, wherein the security key comprises a vehicle identification number (VIN).

4. The apparatus according to claim 1, wherein the security key is selected from the group consisting of a serial number, a manufacturer code, a manufacturer password, and a user password.

5. The apparatus according to claim 1, further comprising a digital processor coupled to the at least one CAN receive buffer and the at least one CAN transmit buffer.

6. The apparatus according to claim 4, wherein the digital processor is a microcontroller.

7. The apparatus according to claim 5, wherein the digital processor is selected from the group consisting of a microprocessor, a digital signal processor, a programmable logic array (PLA), and an application specific integrated circuit (ASIC).

8. The apparatus according to claim 1, wherein the CAN device becomes inoperative if unauthorized use of it is made in a CAN system.

9. The apparatus according to claim 1, wherein communications occurs only between CAN devices having the same security key.

10. A system for secure communications between and verification of authorized controller area network (CAN) devices operating in a CAN system, said CAN system comprising:
a plurality of CAN devices, wherein each of the plurality of CAN devices comprises:
a CAN engine having a CAN bus interface adapted for coupling to a CAN bus;
a message assembly buffer having a receive message buffer and a transmit message buffer, the message assembly buffer is coupled to the CAN engine for receiving and transmitting CAN formatted messages;
a security peripheral having an encryption encoder and a decryption decoder, wherein the encryption encoder is coupled to the transmit message buffer and the decryption decoder is coupled to the receive message buffer;
a security key register storing a security key;
a synchronization counter;
a fixed data register;
at least one CAN transmit buffer coupled to the synchronization counter, fixed data register and the encryption encoder; and
at least one CAN receive buffer coupled to the synchronization counter, fixed data register and the decryption decoder;
wherein
the encryption encoder generates encrypted transmit data from transmit data in the at least one CAN transmit buffer using the security key from the security key register and places the encrypted transmit data into the transmit message buffer, and
the decryption decoder converts encrypted received data in the receive message buffer to received data using the security key from the security key register and places the received data into the at least one CAN receive buffer.

11. The system according to claim 10, wherein the each of the plurality of CAN devices communicate with other ones of the plurality of CAN devices having the same security key.

12. A method for secure communications between and verification of authorized controller area network (CAN) devices, said method comprising the steps of:
reading a CAN device identification;
comparing the CAN device identification with a CAN system identification, wherein if the CAN device identification matches the CAN system identification, then activating the CAN device;
sending status of the activated CAN device to the CAN system; and
saving the status of the activated CAN device.

13. The method according to claim 12, wherein the activated CAN device identification is changed to a new identification.

14. The method according to claim 12, wherein the CAN device is disabled if the CAN device identification does not match the CAN system identification.

15. The method according to claim 14, wherein the disabled CAN device is rendered inoperable until re-enabled by an authorized programming device.

16. The method according to claim 15, wherein the authorized programming device compares the CAN device identification with an identification list of stolen CAN devices.

17. The method according to claim 16, wherein the CAN device identification is changed to a new identification if the CAN device identification is not found in the identification list of stolen CAN devices.

18. The method according to claim 16, wherein the CAN device identification and location are reported if the CAN device identification is found in the identification list of stolen CAN devices.

19. The method according to claim 16, wherein the CAN device identification and location are reported if the CAN device is used in an improper application.

20. A method for secure communications between and verification of authorized controller area network (CAN) devices, said method comprising the steps of:
reading a first CAN device identification;
determining if the first CAN device identification is valid; and
replacing the first CAN device identification with a second CAN device identification if the first CAN device identification is valid.

21. The method according to claim 20, wherein the CAN device is disabled if the first CAN device identification is not valid.

22. The method according to claim 21, wherein the disabled CAN device is rendered inoperable until re-enabled by an authorized programming device.

23. The method according to claim 22, wherein the authorized programming device compares the first CAN device identification with an identification list of stolen CAN devices.

24. The method according to claim 22, wherein the first CAN device identification is changed to the second CAN device identification if the first CAN device identification is not found in the identification list of stolen CAN devices.

25. The method according to claim 23, wherein the first CAN device identification and location are reported if the first CAN device identification is found in the identification list of stolen CAN devices.

26. The method according to claim 23, wherein the first CAN device identification and location are reported if the first CAN device is used in an improper application.
